(19) United States
(12) Patent Application Publication
(10) Pub. No.: US 2025/0209224 A1
(43) Pub. Date: Jun. 26, 2025

(54) AUTOMATIC SPACE LAYOUT DESIGN METHOD FOR PLURALITY OF OBJECTS, AND RECORDING MEDIUM ON WHICH PROGRAM FOR EXECUTING AUTOMATIC SPACE LAYOUT DESIGN METHOD FOR PLURALITY OF OBJECTS IS RECORDED

(71) Applicant: SAPNDA CO.,LTD., Daejeon (KR)

(72) Inventor: Woo Jae SUNG, Seongnam-si, Gyeonggi-do (KR)

(21) Appl. No.: 18/847,009

(22) PCT Filed: Mar. 6, 2023
(86) PCT No.: PCT/KR2023/003030

§ 371 Date: Sep. 13, 2024

(30) Foreign Application Priority Data
Mar. 16, 2022 (KR) 10-2022-0032919

(51) Int. Cl. G06F 30/13

(52) U.S. Cl. CPC G06F 30/13

(57) ABSTRACT

A method for automatically designing a spatial arrangement for a plurality of objects and a recording medium having a program for executing the method for automatically designing a spatial arrangement for a plurality of objects recorded thereon are described. An embodiment is implemented by a design device through the processes of: searching for a cell at a specific location in a grid area overlapping a site, which is an area where the plurality of objects are arranged; arranging a first object among the plurality of objects on the cell at the specific location based on priority information about the type of objects arranged on the site; and determining a validity of the object arrangement.

### TECHNICAL FIELD

The present invention relates to a method for automatically designing a spatial arrangement for a plurality of objects and a recording medium having a program for executing the method for automatically designing a spatial arrangement for a plurality of objects recorded therein, and more specifically, to a method for automatically designing a spatial arrangement for a plurality of objects, which may automate the design of the spatial arrangement for objects to arrange a plurality of objects within the limited space, thereby greatly improving the efficiency and economic advantages of the spatial arrangement design, and a recording medium having a program for executing the method for automatically designing a spatial arrangement for a plurality of objects recorded therein.

### BACKGROUND ART

In order to optimally arrange a plurality of objects within the limited space, various factors such as spatial information, for example the size and shape of a space where the objects are arranged, related laws and design standards for the arrangement of objects such as a minimum separation distance between the plurality of objects, and the like should be comprehensively considered.

Due to these complex factors that should be considered during design the spatial arrangement, numerous trial and error and redesign processes are inevitably involved when designing the spatial arrangement for the plurality of objects, and consequently, time and costs for the design work of the spatial arrangement will be greatly increased.

Meanwhile, designs for optimally arranging a plurality of objects within the limited space are being made in a wide variety of fields, and a representative example includes a design for arranging buildings in an apartment complex.

Unlike most typical buildings where the design is performed based on static backgrounds such as already existing surrounding buildings and the environment, etc., the design of the apartment complex is characterized by performing the design of a plurality of buildings simultaneously and including dynamic features such as the mutual influence on each other's arrangement and the number of floors due to conditions such as a distance between the buildings.

As described above, the design process of the apartment complex involves a large number of variables and cases beyond compare with the design of a typical single building, and undergoes the inevitable process of trial and error, which in turn leads to intensive investment of skilled manpower and time in practice.

Specifically, daylight is one of the most important factors to consider in the building design, but it is not easy to quantify its influence during the design process. Therefore, architects will reach the final design through numerous trial and errors and design repetitions.

### SUMMARY OF INVENTION

### Problems to be Solved by Invention

Accordingly, an object of the present invention is to provide a method for automatically designing a spatial arrangement for a plurality of objects, which may automate the design of the spatial arrangement for objects to arrange a plurality of objects within the limited space, thereby greatly improving the efficiency and economic advantages of the spatial arrangement design, and a recording medium having a program for executing the method for automatically designing a spatial arrangement for a plurality of objects recorded therein.

The problem to be solved by the present invention is not limited to the above-described problems, and may include other technical problems that can be clearly understood by those skilled in the art from the following description.

### Means for Solving Problems

To achieve the above object, according to an aspect of the present invention, there is provided a method for automatically designing a spatial arrangement for a plurality of objects, which includes: (a) searching for, by a design device, a cell at a specific location in a grid area overlapping a site, which is an area where the plurality of objects are arranged; (b) arranging, by the design device, a first object among the plurality of objects on the cell at the specific location based on priority information about the type of objects arranged on the site; (c) determining, by the design device, a validity of the object arrangement; and (d) limiting, by the design device, an area where a next object can be arranged based on the validity determination.

Preferably, the specific location is far northwest in the grid area.

In addition, before the step (a), the method may further include determining, by the design device, an attribute value for a cell at the site boundary among the cells forming the grid area.

In addition, before the step (a), the method may further include receiving, by the design device, information necessary for calculating a minimum distance between the plurality of objects.

According to another aspect of the present invention, there is provided a recording medium having a program recorded therein to execute the above-described method.

### Advantageous Effects

According to the present invention, by automating the design of a spatial arrangement for objects to arrange a plurality of objects within the limited space, the efficiency and economic advantages of the spatial arrangement design may be greatly improved.

The effect of the present invention is not limited to the above-described effects, and may include other effects that can be clearly understood by those skilled in the art from the following description.

### BRIEF DESCRIPTION OF DRAWINGS

FIG. 1 is a view illustrating a data input module, calculation module and visualization output module of a design device according to the present invention.

FIG. 2 is a view illustrating a continuous domain (left) and an individual patch (right) for comparison in the present invention.

FIG. 3 is a view illustrating sequential processes executed in the design device according to the present invention.

FIG. 4 is a view illustrating results in accordance with the sequential processes executed in the design device according to the present invention.

FIG. 5 is a view illustrating a site boundary, grid angle and grid dimension in the present invention.

FIG. 6 is a view illustrating a building footprint, boundary cell and grid in the present invention.

FIG. 7 is a view illustrating application examples in an oblique building and a right-angled building in the present invention.

FIG. 8 is a view illustrating a unique building arrangement state in two cases where priorities for the building type are different in the present invention.

FIG. 9 is a view illustrating an input state of the building height and minimum distance in the present invention.

FIG. 10 is a view describing a floor area ratio (FAR) and building coverage ratio (BCR) in the present invention.

FIG. 11 is a view illustrating a site bounding box and grid in the present invention.

FIG. 12 is a view describing whether the cell includes a boundary (Cell Containment) in the present invention.

FIG. 13 is a view describing cell functions in the present invention.

FIG. 14 is a view describing the far northwest cell in a grid area of the present invention.

FIG. 15 is a view illustrating the far northwest successful cell outside the site boundary in the present invention.

FIG. 16 is a view describing an initial building arrangement in the present invention.

FIG. 17 is a view describing a cell-building alignment in the present invention.

FIG. 18 is a view describing validity check in the present invention.

FIG. 19 is a view describing a mirroring building in the present invention.

FIG. 20 is a view describing a repetition procedure in the present invention.

FIG. 21 is a view describing display of a minimum distance in the present invention.

FIG. 22 is a view describing termination conditions in the present invention.

FIG. 23 is a flowchart illustrating the entire process for implementing a method for automatically designing a spatial arrangement for a plurality of objects according to an embodiment of the present invention.

### MODE FOR CARRYING OUT INVENTION

Hereinafter, the present invention will be described with reference to the accompanying drawings in detail. Referring to the drawings, like reference characters designate like or corresponding parts throughout the several views. In the embodiments of the present invention, the publicly known functions and configurations that are judged to make the purport of the present invention unnecessarily obscure will not be described.

A design device for executing a method for automatically designing a spatial arrangement for a plurality of objects according to the present invention sequentially arranges the objects such as buildings in a grid area overlapping with a site, which is an area where the plurality of objects are arranged, using grid-based packing.

The grid overlapped on a site boundary has cells with a property of function in the present invention, and the function of each cell indicates whether a building can be arranged in the corresponding cell according to the geometric configuration.

Instead of repeating thorough repetition and simultaneous calculation to set and evaluate locations of the buildings, the design device according to the present invention simply searches for the function of the cell to check the availability for a new building.

The function of the cell described above is updated whenever there is a geometric change, and this process continues to track the function of the cell while adding the buildings until there is no more available cell or until it satisfies the predetermined floor area ratio/building coverage ratio.

This method not only eliminates the need for many repetitions or timeline-based simulations so that users can expect real-time feedback, but also eliminates the need for users to hastily guess the number or location of the buildings in advance.

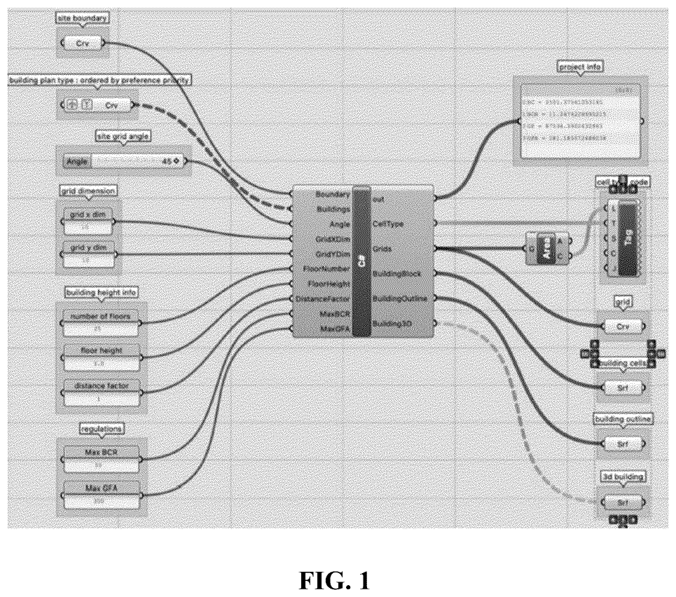

Meanwhile, the method for automatically designing a spatial arrangement for a plurality of objects according to the present invention utilizes C # scripting components in Rhino 3D and Grasshopper environments as shown in FIG. 1, which may be composed of three parts including data input, calculation and visualization output.

The cyan components on the left side in FIG. 1 receive user input in both numbers and geometric shapes, the C # components at the center in FIG. 1 calculate results, and the green items on the right side in FIG. 1 visualize the calculation results.

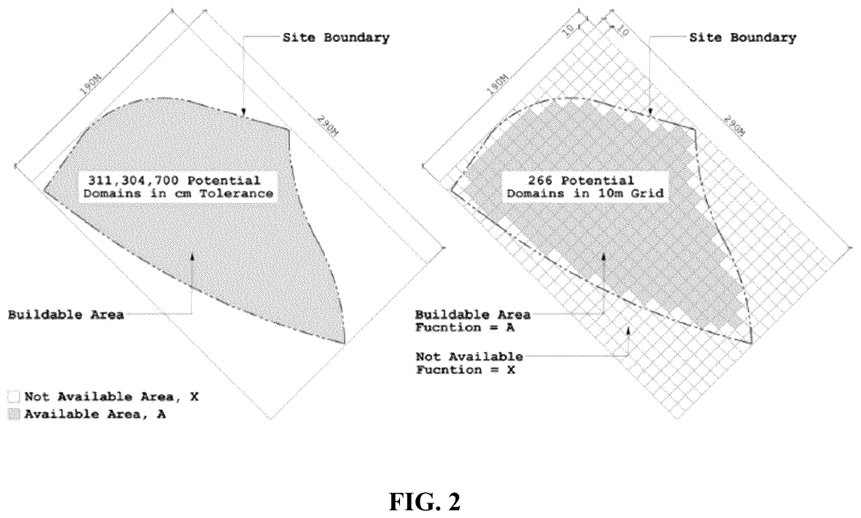

FIG. 2 is a view illustrating a continuous domain (left) and an individual patch (right) for comparison in the present invention. The process in the design device according to the present invention pixelates the given site shape by overlaying rectangular grids.

The pixels simplify the calculation by converting a continuous area into a discrete cell patch, and an inherent property of the function, which represents the availability of the cell capable of hosting the building, is assigned to each cell.

Meanwhile, in carrying out the present invention, it is preferable that the design device filter the cells through the site boundary so as to grasp whether the process is inside or outside before testing the availability of the cell for the building.

As shown in FIG. 2, the attribute function may be A (Available) or X (Not available) depending on whether the cell is included in the site boundary.

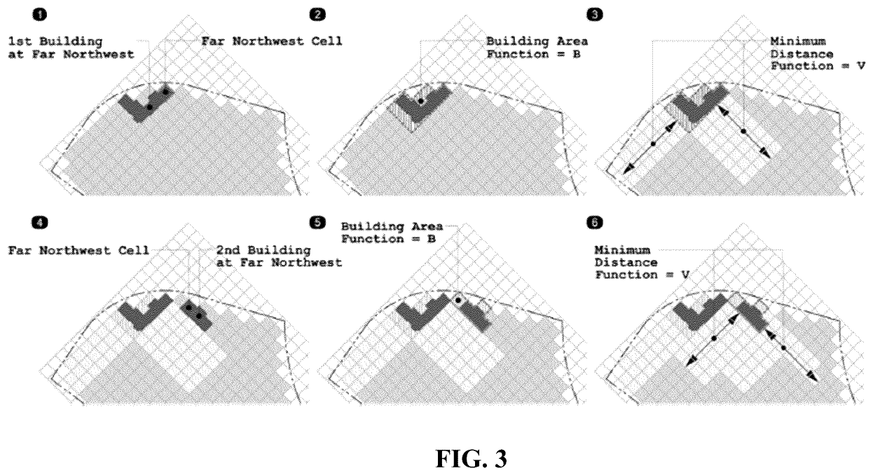

FIG. 3 is a view illustrating sequential processes executed in the design device according to the present invention. The gray area in FIG. 3 represents an area where a building can be constructed, and when checking whether the cell includes a boundary is completed, the design device starts to sequentially arrange the buildings in the following order.
1) Search for the far northwest cell.
2) Identify the building boundary cell and update the function to B (Building).
3) Search for a cell to be invalidated based on the minimum distance rule, and update the function of the searched cell to V (Void).
4) Repeat the above procedures of 1) to 3) for the next building.

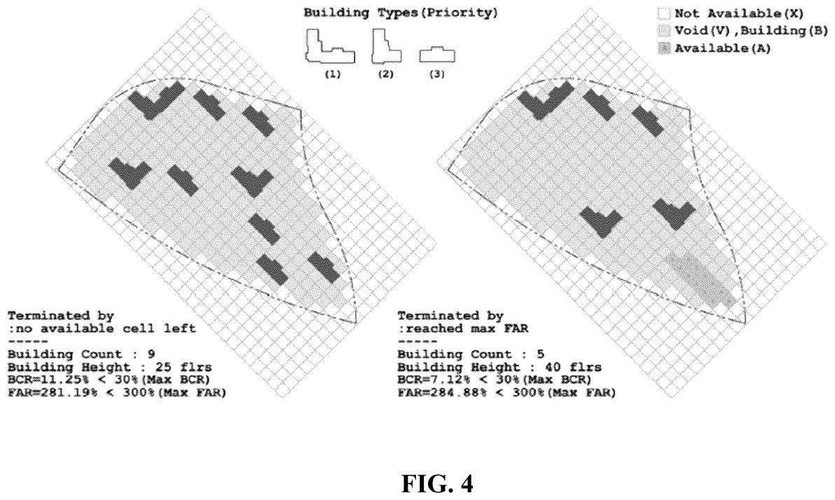

FIG. 4 is a view illustrating results in accordance with the sequential processes executed in the design device according to the present invention. The design device according to the present invention repeats the process until there is no more available cell as on the left side in FIG. 4, or until a floor area ratio (FAR) or a building coverage ratio (BCR) reaches the maximum value set by the zoning regulations as on the right side in FIG. 4.

User input types and formats in the design device according to the present invention are summarized in Table 1 below.

TABLE 1

| Data | | | Fixed | Flexible |
|---|---|---|---|---|
| Type | Data Name | Data Format | (Zoning) | (Users) |
| Geometric | Site Boundary | Rhino3d Curve | 0 | |
| | Building Types | Rhino3d | | 0 |
| | | Polyline(s) | | |
| Numeric | Grid Angle | Integer | | 0 |
| | Grid X Dimension | Double | | 0 |
| | Grid Y Dimension | Double | | 0 |
| | Floor Count | Integer | | 0 |
| | Floor Height | Integer | | 0 |
| | Distance factor | Double | 0 | |
| | Max BCR (Building | Integer | 0 | |
| | Coverage Ratio) | | | |
| | Max FAR (Floor | Integer | 0 | |
| | Area Ratio) | | | |

### (1) Input Site and Grid

The site (land) boundary indicates an area where buildings can be located. The boundary curve may be two-dimensional or three-dimensional curve. Since only the projected distance between the buildings in an XY plane is considered when applying the minimum distance rule, it does not make a difference in the building height.

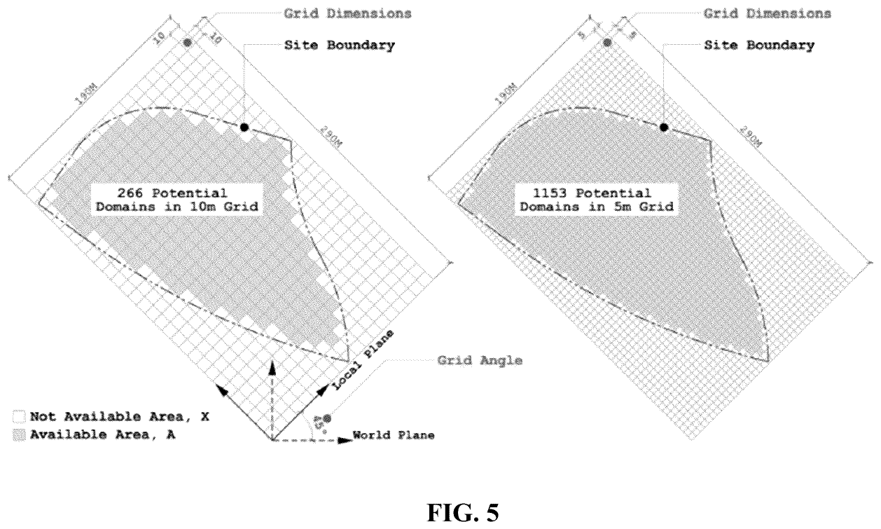

FIG. 5 is a view illustrating a site boundary, grid angle and grid dimension in the present invention. As shown in FIG. 5, the grid overlapped on the site enables the user to identify an area where the object can be constructed on the site.

The user may freely change the grid dimension and angle into world coordinates by inputting them in the design device, and in most cases, an angle of 45 degrees is most satisfactory from the daylight of view, because it allows the southern half of the building to face toward the south evenly.

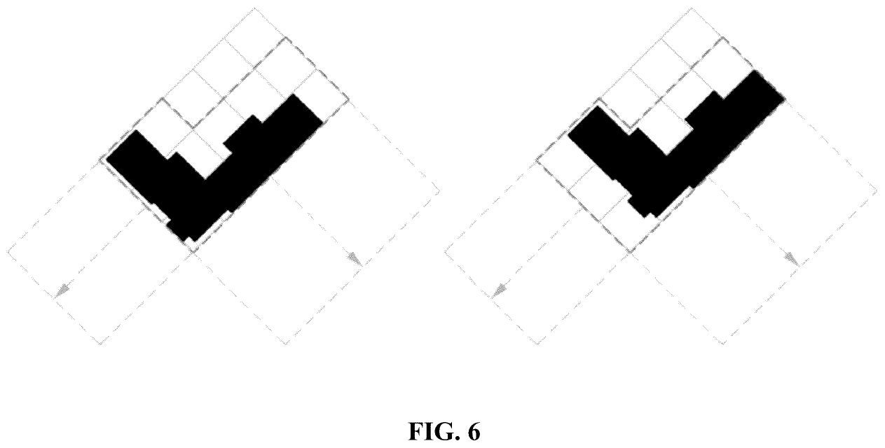

FIG. 6 is a view illustrating a building footprint, boundary cell and grid in the present invention.

The pixels are intended to simplify the calculation, and when applying the minimum distance rule for adjacent buildings in the case where a building plan view is within the same polygonal boundary, it can be considered that the buildings within the corresponding boundary are the same as each other.

### (2) Input Building Plan Type

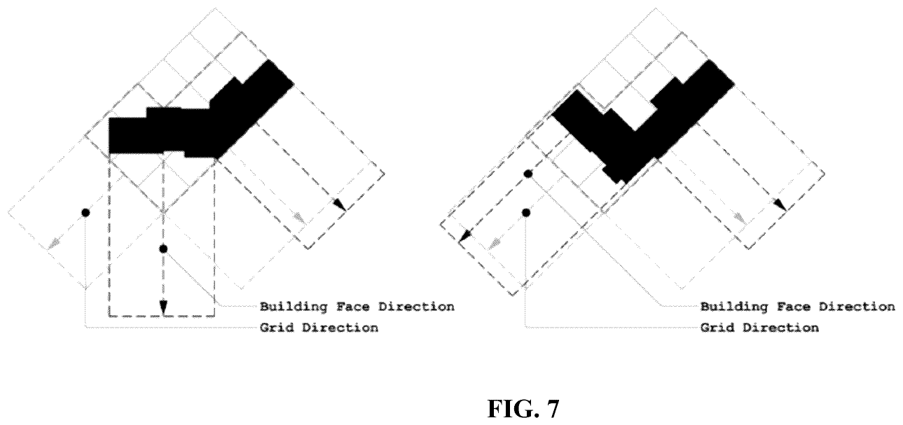

FIG. 7 is a view illustrating application examples in an oblique building and a right-angled building in the present invention. The building type in FIG. 7 represents a series of plan view shapes.

The user may set the type and number of the buildings according to the design intent. However, in order to take full advantage of the rectangular grid described above, it is preferable that the plan view shapes of the buildings are right-angled or rectangular.

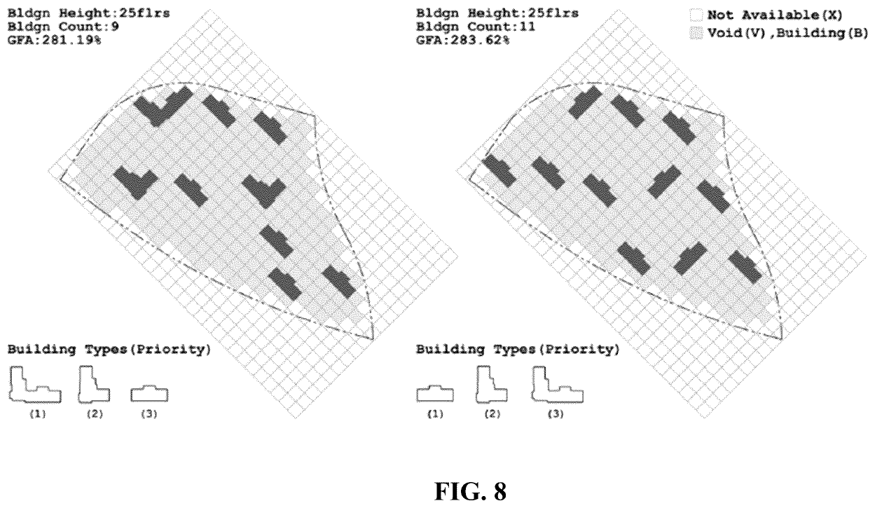

FIG. 8 is a view illustrating a unique building arrangement state in two cases where priorities for the building type are different in the present invention. When inputting the building type into the Grasshopper, the user may select the building type in the order of user's preference.

It can be confirmed as shown in FIG. 8 that, although the same building height, floor area ratio (FAR), building coverage ratio (BCR) and building type pool are shared, the arrangements are different from each other due to the difference in the priorities for the building type.

### (3) Input Building Height and Minimum Distance

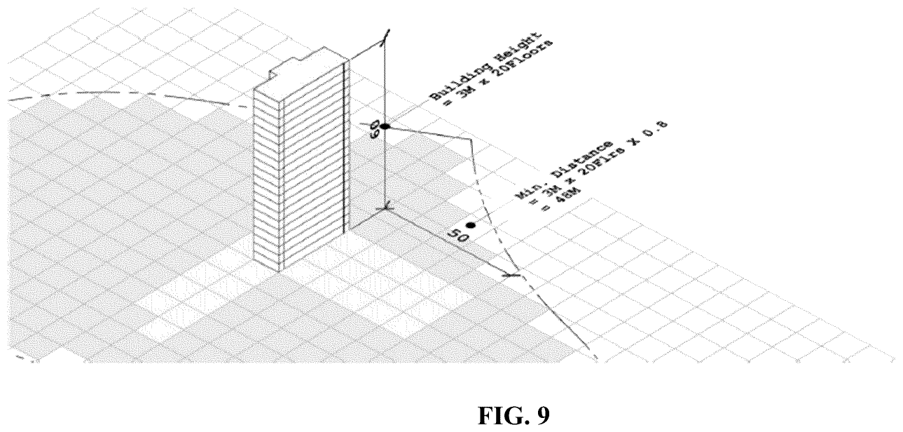

FIG. 9 is a view illustrating an input state of the building height and minimum distance in the present invention. In carrying out the present invention, in order to calculate the minimum distance from a building to another building by the design device according to the present invention, the user may input floor-to-floor heights, the number of floors, and distance coefficient.

Generally, the range of the distance coefficient may be from 0.5 in dense urban areas to 1.0 or more in other areas, and the design device may calculate the minimum distance between the buildings by multiplying the three input values as shown in FIG. 9.

### (4) Constraints by Local Laws/Ordinances for Use (Zoning Regulation Constraints)

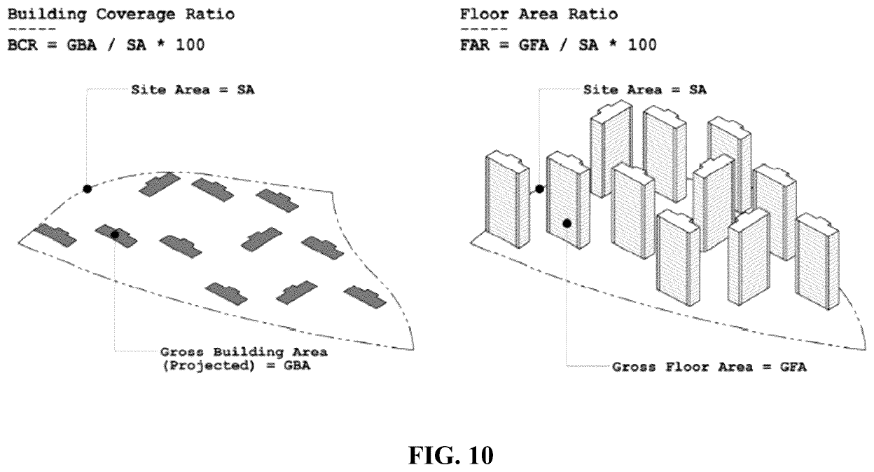

FIG. 10 is a view describing the floor area ratio (FAR) and building coverage ratio (BCR) in the present invention. The maximum floor area ratio (FAR) and building coverage ratio (BCR) ensure that the automated building layout does not violate the zoning regulations of the corresponding local.

The floor area ratio (FAR) is a ratio of a total floor area of all buildings to a site area, and the building coverage ratio (BCR) is a ratio of a total projected area of all buildings to the land area.

The design device according to the present invention executes a process to automatically update the cumulative building coverage and total floor area when securing the location of the building on the site, and determine whether the floor area ratio (FAR) and building coverage ratio (BCR) satisfy the predetermined upper limits thereof.

Hereinafter, the execution process of the method for automatically designing a spatial arrangement for a plurality of objects according to an embodiment of the present invention will be described step by step.

### (1) Site Bounding Box and Grid

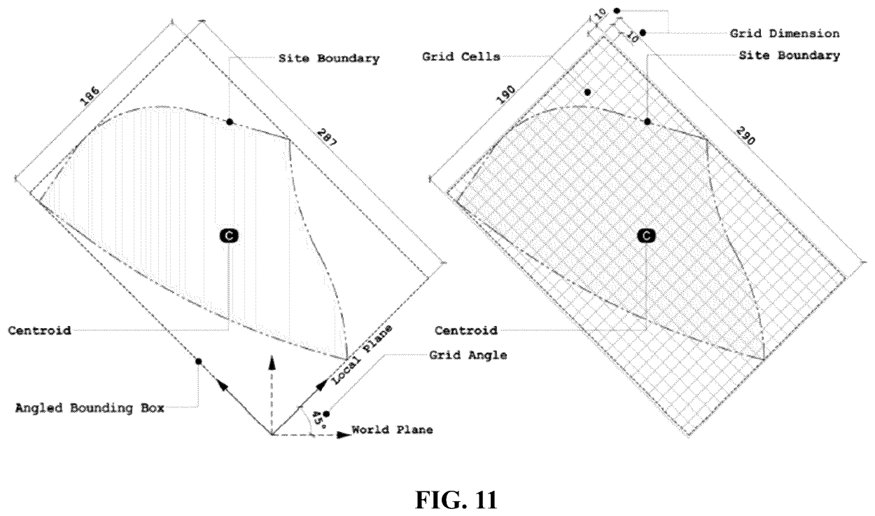

FIG. 11 is a view illustrating a site bounding box and grid in the present invention. First, the design device generates an angled bounding box on the site based on angle information input by the user. Here, the angle input by the user controls the direction of the entire system.

Then, the design device calculates a centroid of the bounding box, calculates the total number of cells along the x and y axes in the local plane, and subdivides the bounding box into a grid system about the calculated centroid.

In carrying out the present invention, it is preferable that the entire grid system is large enough to entirely include the site boundary.

(2) Grid Cells with Functions

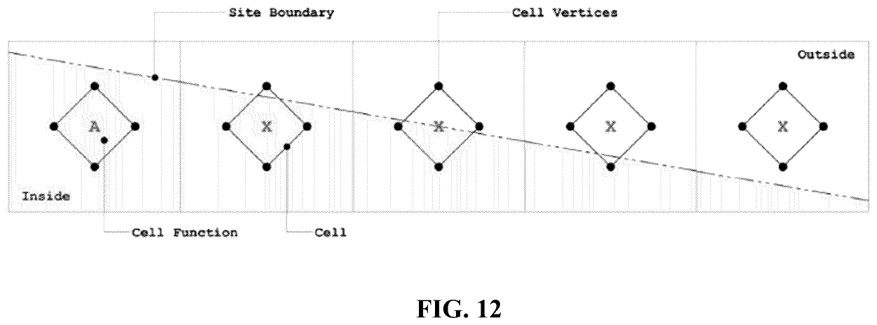

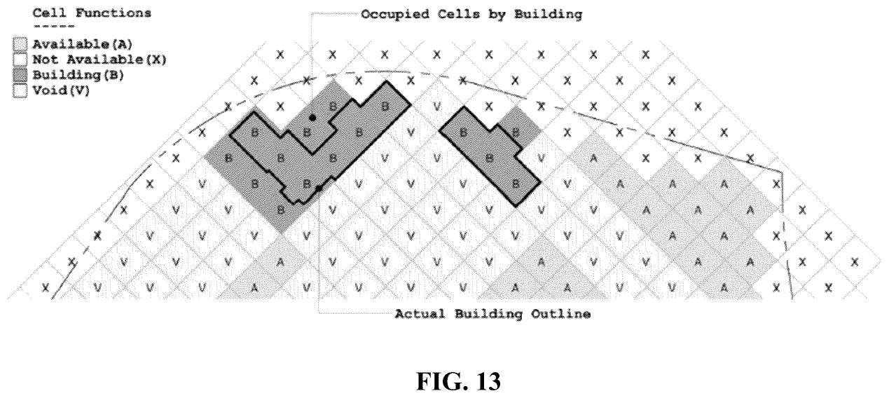

FIG. 12 is a view describing whether the cell includes a boundary (Cell Containment) in the present invention, and FIG. 13 is a view describing cell functions in the present invention.

The design device according to the present invention tests the relationship between the respective cells with respect to the site boundary. The cell function represents the properties of the cell, and may have one of the following four value types depending on the geometric relationship between the building and the site boundary.
A: Available, the cell can be used for buildings.
X: Not available, the cell is outside or intersecting the site boundary.
B: Building, the cell is occupied by all or a part of the building.
V: Void, a space intended to maintain the buildings apart from each other.

Specifically, the design device according to the present invention determines that the cell is inside if all vertices of the cell are included in the site boundary, and determines that the cell is outside if any one of the vertices deviates from the site boundary.

As shown in FIG. 12, the function of the cell becomes A or X at this stage depending on the cell containment conditions. The cell, of which the function value is A, is changed into B or V later as shown in FIG. 13.

When the calculations reach the maximum floor area ratio (FAR) or building coverage ratio (BCR) limit, the design device terminates the repetition as shown on the right side in FIG. 4, otherwise, the function value is eventually changed into V or B as shown on the left side in FIG. 4.

### (3) Far Northwest Cell

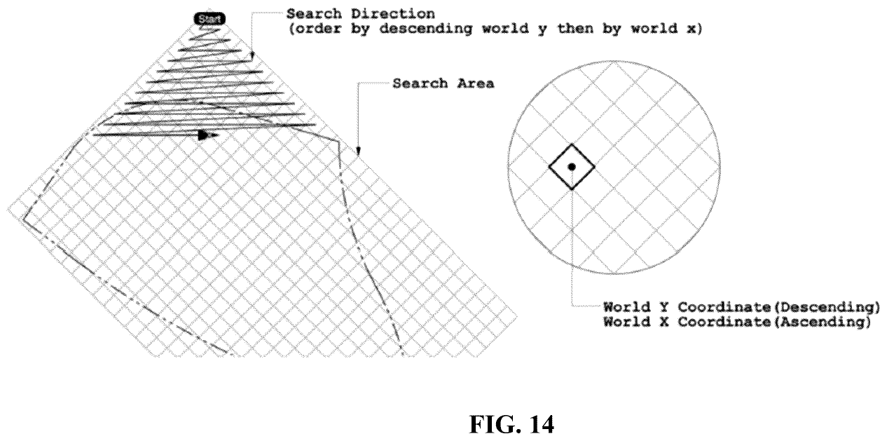

FIG. 14 is a view describing the far northwest cell in a grid area of the present invention. It is important for the design device to arrange a first building on the site because it may affect the location of the next building and consequently the overall arrangement of the buildings.

In order to arrange the buildings on the grid as shown in FIG. 3, the design device should search for a reference cell, and it is preferable to start the search from the northwest end in order to minimize a space where there is sunless behind the building.

As shown in FIG. 14, the design device according to the present invention may search for the far northwest cell by aligning Y (descending) coordinates and X (ascending) coordinates of the cells in the XY plane of the world coordinates. This allows the design device to arrange the buildings toward the northwest, thereby securing more space on the southeast side.

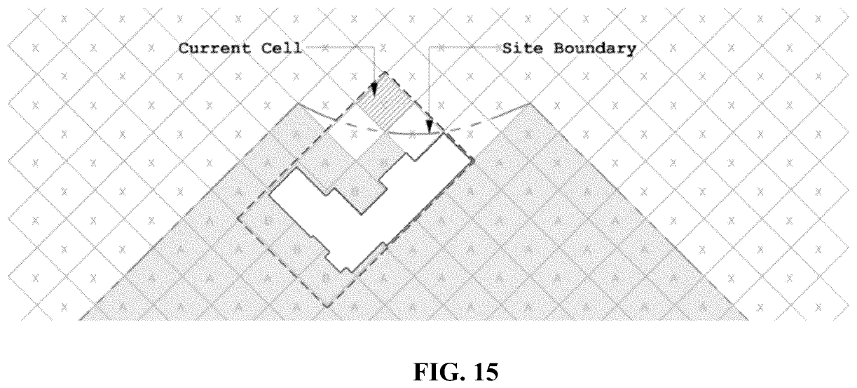

FIG. 15 is a view illustrating the far northwest successful cell outside the site boundary in the present invention. The design device according to the present invention may search for all available cells, not just cells within the site boundary, when searching for the far northwest cell, and in some cases, even if the reference cell deviates from the site boundary, the building can be located inside the site as shown in FIG. 15.

### (4) Cell Formation Alignment

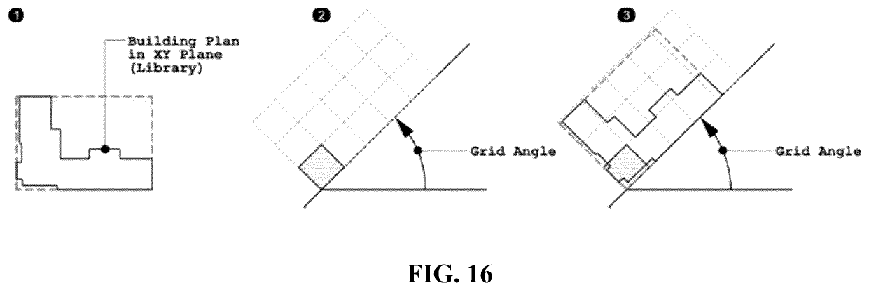

FIG. 16 is a view describing an initial building arrangement in the present invention. Then, the design device arranges a building with the highest priority in a building list on the far northwest cell.

As shown in FIG. 16, the building rotates to meet the rotated grid in the process of being arranged on the cell. Since the priority for the building type reflects the design intent, the building arrangement will vary depending on the priority for the building type as shown in FIG. 8.

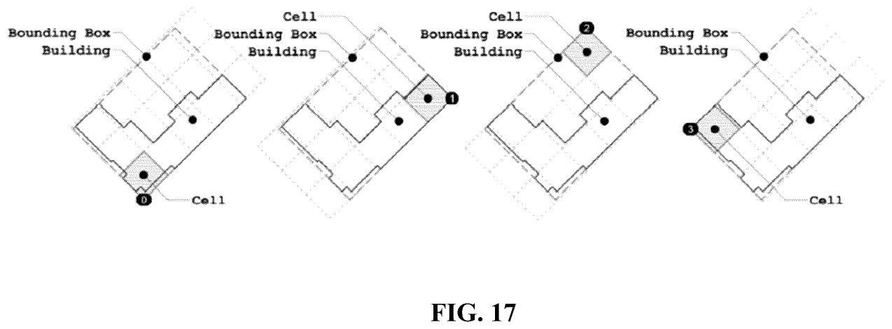

FIG. 17 is a view describing a cell-building alignment in the present invention. The size of the cell may be selected by the user, but it is generally preferable to form the cell smaller than the building because a cell larger than the building is inefficient in approximating the complex shape of the building.

As shown in FIG. 17, there are four cases where the design device aligns the building to the reference cell. Since the building is not always rectangular, as shown in FIG. 17, the design device generates a rectangular boundary which includes the building, and aligns the building to the reference cell using the generated rectangular boundary.

### (5) Confirmation of Validity

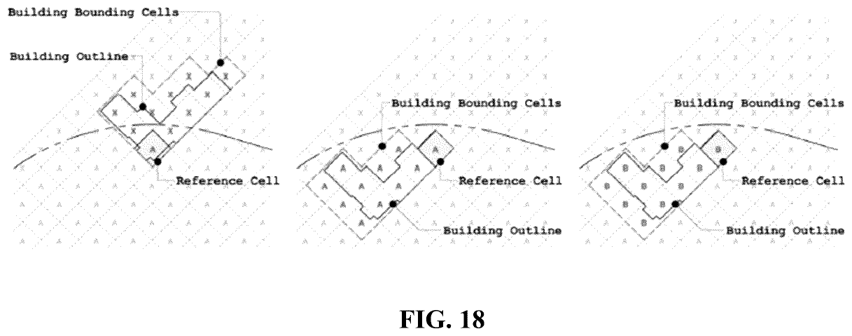

FIG. 18 is a view describing validity check in the present invention. The left side in FIG. 18 represents the case of failure, and the center and right side represent the cases of success.

The design device according to the present invention may perform the location confirmation of the building through a two-step process. Specifically, the design device finds cells surrounding a space of the building and determines whether all the functions of the corresponding cells are A (Available).

The design device determines that the cell is a peripheral portion of the building when 1) the center of the cell is within an outline of the building, or 2) a distance between the cell center and the building boundary is less than half of the cell dimension.

The left side in FIG. 18 does not pass a success reference because some of the functions of the boundary cells are not A (Available), and the center in FIG. 18 passes the success reference because all the cell functions are A (Available). If the alignment is successful, the function of the boundary cell is changed into B (Building) before the next repetition, as shown on the right side in FIG. 18.

### (6) Mirroring Building

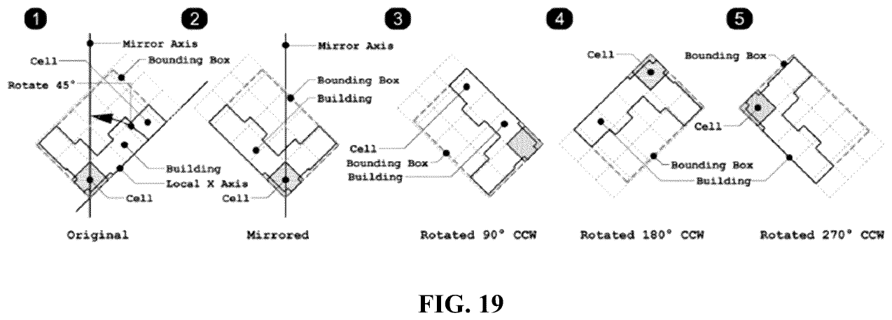

FIG. 19 is a view describing a mirroring building in the present invention. In an order from the left side in FIG. 19, it represents (1) original, (2) mirrored, (3) rotated 90 CCW, (4) rotated 180 CCW, and (5) rotated 270 CCW.

The design device according to the present invention tests all unsuccessful cell building alignments [(1) in FIG. 19], and then repeats the test fitting with the mirrored plan [(2) in FIG. 19]. A mirroring axis becomes a local X-axis rotated by 45 degrees to maintain the mirrored plane so as to align it with a local grid [(1) in FIG. 19].

Mirroring, not rotation, maintains the building so that a long face thereof faces toward the south, rather than a portion (armfit) or a side where building planes meet at an angle of 90 degrees faces toward the south [(3), (4) and (5) in FIG. 19].

As such, the mirrored plan undergoes the cell building alignment and a process for checking validity described above.

### (7) Repetition

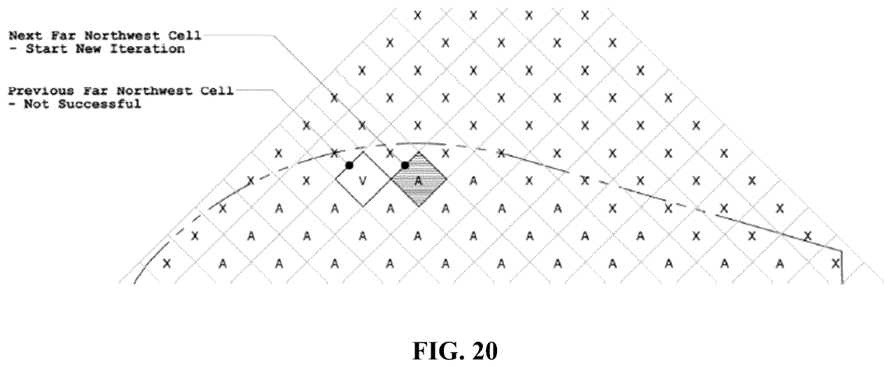

If none of the alignment and mirror combinations described above successfully secures the location of the building, the design device takes the next building from the building type list in the order of priority and repeats the above process. FIG. 20 describes this repetition procedure.

As shown in FIG. 20, if all the building types fail to secure the location of the building in the current cell, the cell cannot host a building under the predetermined conditions, such that the function of the cell is switched to the V (Void).

Then, the design device searches for the next far northwest cell in northwestern in order to continue the process.

### (8) Minimum Distance

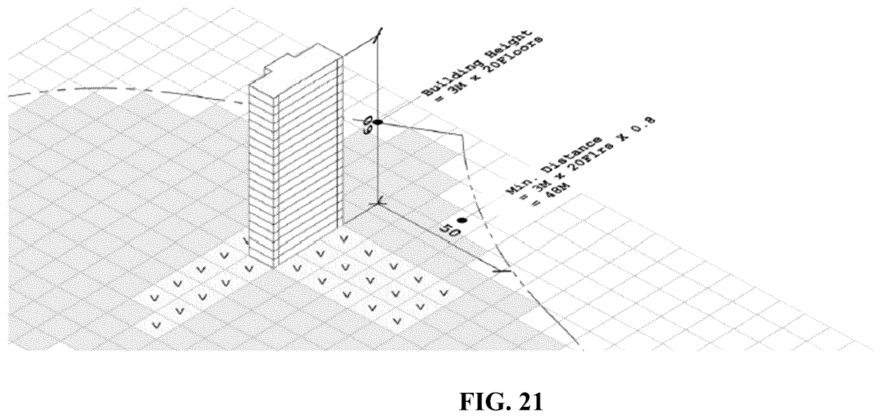

FIG. 21 is a view describing display of a minimum distance in the present invention. When successfully finding the location of the building in the cell, the design device changes the function of the corresponding cell into V as the next step, and displays the minimum distance on the grid as shown in FIG. 21.

Specifically, the design device may calculate the number of cells to be invalidated by multiplying a building height input value (the floor height, the number of floors and distance coefficient) by a value divided by the cell dimensions.

### (9) Termination Conditions

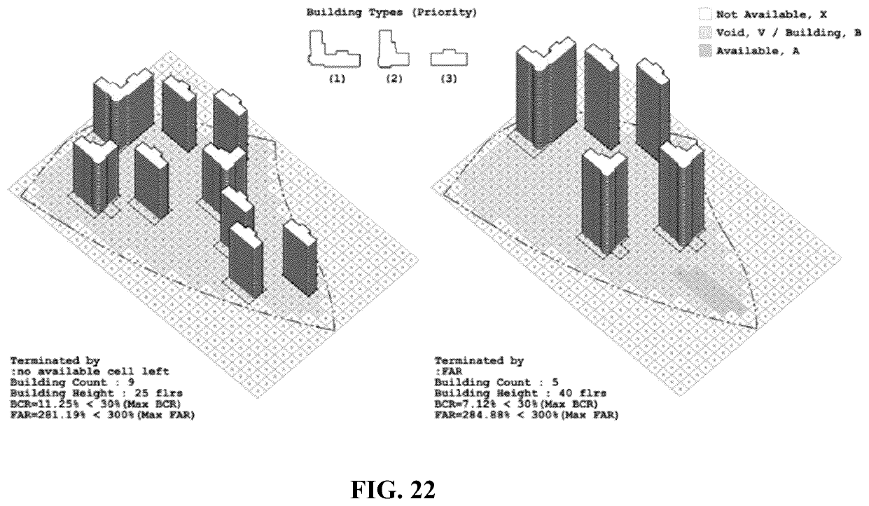

FIG. 22 is a view describing termination conditions in the present invention. As shown on the left side in FIG. 22, the design device according to the present invention terminates the process if there is no available cell left after a predetermined number of repetitions. However, as shown on the right side in FIG. 22, the process may be terminated earlier if the accumulated floor area ratio (FAR) or building coverage ratio (BCR) reaches the maximum value set by the zoning regulations.

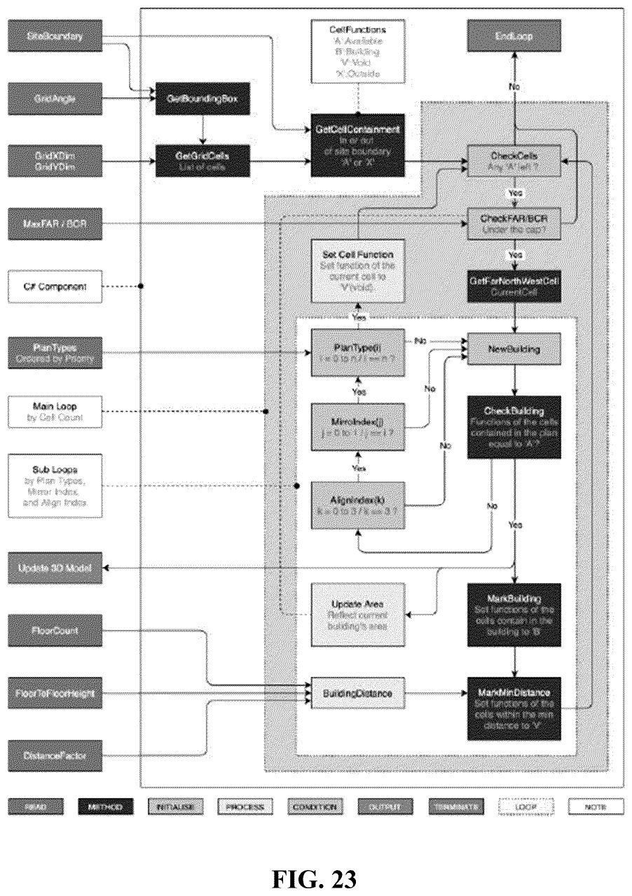

FIG. 23 is a flowchart illustrating the entire process for implementing a method for automatically designing a spatial arrangement for a plurality of objects according to an embodiment of the present invention.

As shown in FIG. 23, when an input value is received form the user, the design device according to the present invention first generates a site bounding box and a grid cell. Then, the design device searches for a farthest northwest cell from the center of the grid where it will start to repeat.

The code of the design device according to the present invention has four inner loops including per total cell count, plan type, mirror index and alignment index.

The loop tests all possible building arrangements, and updates the cell functions and a 3D model according to the test results.

The calculation is stopped when the loop reaches the termination conditions, such as there is no available cell or the floor area ratio (FAR) or building coverage ratio (BCR) exceeds the maximum value.

In carrying out the present invention, a program for executing the method for automatically designing a spatial arrangement for a plurality of objects may be installed in the design device according to the present invention, recorded on various computer-readable recording media, or stored in the server that transmits the corresponding program through a network.

Terms used in the present invention are used only to describe specific embodiments, and are not intended to limit the present invention. Singular expressions used herein include plural expressions unless they have definitely opposite meanings in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

While the present invention has been described with reference to the preferred embodiments and modified examples, the present invention is not limited to the above-described specific embodiments and the modified examples, and it will be understood by those skilled in the art that various modifications and variations may be made therein without departing from the scope of the present invention as defined by the appended claims, as well as these modifications and variations should not be understood separately from the technical idea and prospect of the present invention.

### INDUSTRIAL APPLICABILITY

The present invention may be applied to the fields of design of a spatial arrangement for objects, such that industrial applicability thereof may be recognized.

1. A method for automatically designing a spatial arrangement for a plurality of objects, the method comprising:
(a) searching for, by a design device, a cell at a specific location in a grid area overlapping a site, which is an area where the plurality of objects are arranged;
(b) arranging, by the design device, a first object among the plurality of objects on the cell at the specific location based on priority information about the type of objects arranged on the site;
(c) determining, by the design device, a validity of the object arrangement; and
(d) limiting, by the design device, an area where a next object can be arranged based on the validity determination.

2. The method according to claim 1, wherein the specific location is far northwest in the grid area.

3. The method according to claim 1, wherein, before the step (a),
further comprising determining, by the design device, an attribute value for a cell at the site boundary among the cells forming the grid area.

4. The method according to claim 1, wherein, before the step (a),
further comprising receiving, by the design device, information necessary for calculating a minimum distance between the plurality of objects.

5. A recording medium having a program recorded therein to execute the method according to claim 1.
